(19) United States
(12) Patent Application Publication
(10) Pub. No.: US 2015/0183103 A1
(43) Pub. Date: Jul. 2, 2015

(54) ENGINE VALVE SPRING REMOVING/INSTALLING KIT

(71) Applicant: PI-LIANG WU, TAICHUNG (TW)

(72) Inventor: PI-LIANG WU, TAICHUNG (TW)

(21) Appl. No.: 14/220,137

(22) Filed: Mar. 20, 2014

(30) Foreign Application Priority Data
Dec. 30, 2013 (TW) 102149144

(51) Int. Cl. B25B 27/26

(52) U.S. Cl. CPC B25B 27/26

(57) ABSTRACT

An engine valve spring removing/installing kit includes a frame, an arm, an adjustment device and a presser. The frame includes a base, two legs and a post. The two legs are connected to the underside of the base. The base is fixed to the engine and the post extends from the top of the base. The arm is pivotably and radially connected to the post. An elongate slot is defined through the arm. The adjustment device includes a retainer, a threaded rod and a rotary member. The retainer is located on one side of the arm and movable along the slot. The ball is rotatably retained in the retainer and the threaded rod extends through the ball. The threaded rod has a connection section extending from the bottom end thereof so as to be connected with the presser which pushes the valve move so as to replace the valve springs.

### BACKGROUND OF THE INVENTION

1. Fields of the Invention

The present invention relates to a tool for maintenance of vehicle engines, and more particularly, to an engine valve spring removing/installing kit especially for V-shaped 6-cylinder engine.

2. Descriptions of Related Art

The conventional engine valve spring removing/installing kit is disclosed in Taiwan Publication No. M245016 and generally comprises two fixed parts, a transverse bar and an operation mechanism, wherein each of the fixed parts has a base. The fixed parts are connected to two ends of the engine. The bases each have a threaded rod which is connected with an adjustment member. An annular member is connected to the top of the threaded rod so that the transverse bar extends through the two respective adjustment members. The operation mechanism has an operation member which has a circular hole defined through the lower portion of the operation member so that the transverse bar extends. The operation member has a connection portion on the top thereof and a socket is connected to the connection portion. The lower portion of the operation portion is connected to an assistance rod and an assistance block so as to be connected with an operation rod. The conventional engine valve spring removing/installing kit is used to replace the engine valve springs.

When in use, the fixed parts are connected to the two ends of the engine and the transverse bar supports the operation mechanism. The operation mechanism is used to replace the engine valve parts so as to replace the valve springs in the engine.

The present invention intends to provide an engine valve spring removing/installing kit so as to increase the efficiency for replacement of the engine valve springs.

### SUMMARY OF THE INVENTION

The present invention relates to an engine valve spring removing/installing kit and comprises a frame having an elongate base, two legs, two bolts and a post. The two legs are connected to the underside of the base and the bolts respectively extend through the legs and the base. The frame is connected to the engine by locking the bolts to the engine. The post extends from the top of the base. An arm is an elongate arm and pivotably and radially connected to the post by a first positioning member. An elongate slot is defined through the arm. An adjustment device has a retainer, a second positioning member, a ball, a third positioning member, a threaded rod and a rotary member. The retainer is located on one side of the arm and has an extension which extends through the slot and is connected with the second positioning member so that the retainer is movable along the slot. The second positioning member locks the retainer. The ball is rotatably retained in the retainer. The third positioning member is threadedly connected to the retainer and contacts the ball to position the ball. The threaded rod extends through the ball and has an operation section on the top end thereof which is cooperated with a tool to rotate the threaded rod. A connection section extends from the bottom end of the threaded rod. A presser is pivotably connected to the connection section. The threaded rod has a support portion extending radially therefrom which is located close to the connection section. The support portion supports the presser and the connection section is connected to the rotary member so that the presser is rotatable relative to the presser. The presser pushes the vale axially so as to replace the valve springs.

Preferably, the base has a passage defined therethrough and the post has an insertion extending from the lower end thereof. The insertion is inserted into the passage.

Preferably, the insertion has a flat contact face defined in the outer periphery thereof. A locking bolt threadedly extends through the base and contacts against the contact face to position the post.

Preferably, the base has two elongate holes defined therethrough. The two legs movably extend through the two elongate holes.

Preferably, the connection section has a bead connected to the outside thereof. The presser has an annular groove with which the bead is engaged so as to pivotably connect the presser with the threaded rod. The presser is pivotable relative to the threaded rod.

Preferably, the presser has a top collar, a bottom collar and two connection rods which are connected between the top and bottom collars. The top collar is pivotably connected to the connection section. The annular groove is defined in the inner periphery of the top collar.

Preferably, the arm has a first end and a through hole is defined through the arm and located close to the first end. The post is pivotably connected to the arm by extending through the through hole. A slit is defined longitudinally through the first end of the arm and communicates with the through hole. Two lugs are formed with the slit located therebetween. The first positioning member extends through the two lugs to lock the arm to the post.

Preferably, the operation section is a polygonal rod.

Preferably, wherein the rotary member has a plate with multiple rollers accommodated therein so as to allow the presser to be rotatable relative to the support portion.

The primary object of the present invention is to provide an engine valve spring removing/installing kit which utilizes the rotatable ball retained in the retainer to allow the presser and the threaded rod to be pivoted about the retainer in different angles and directions so as to conveniently replace or install the valve springs, while the frame is fixed to the engine.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the engine valve spring removing/installing kit of the present invention;

FIG. 2 is an exploded view of the frame of the engine valve spring removing/installing kit of the present invention;

FIG. 3 is an exploded view of the arm and the adjustment device of the engine valve spring removing/installing kit of the present invention, and

FIG. 4 is a perspective view to show the presser of the engine valve spring removing/installing kit of the present invention.

### DETAILED DESCRIPTION OF THE PREFERRED EMBODIMENT

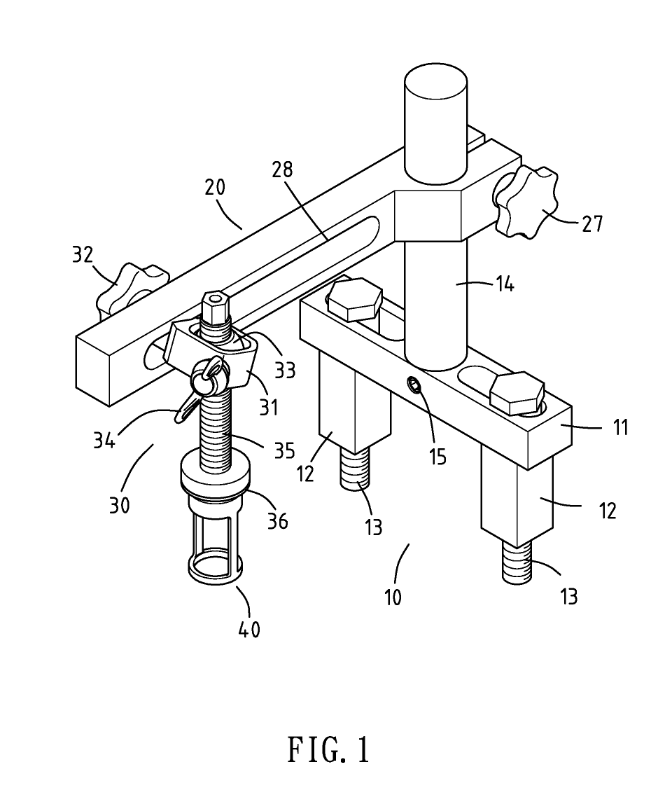

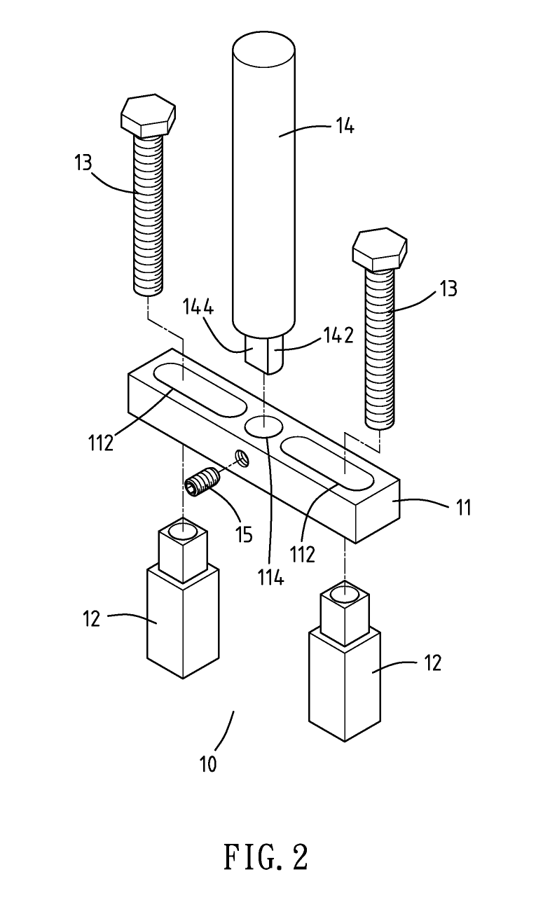

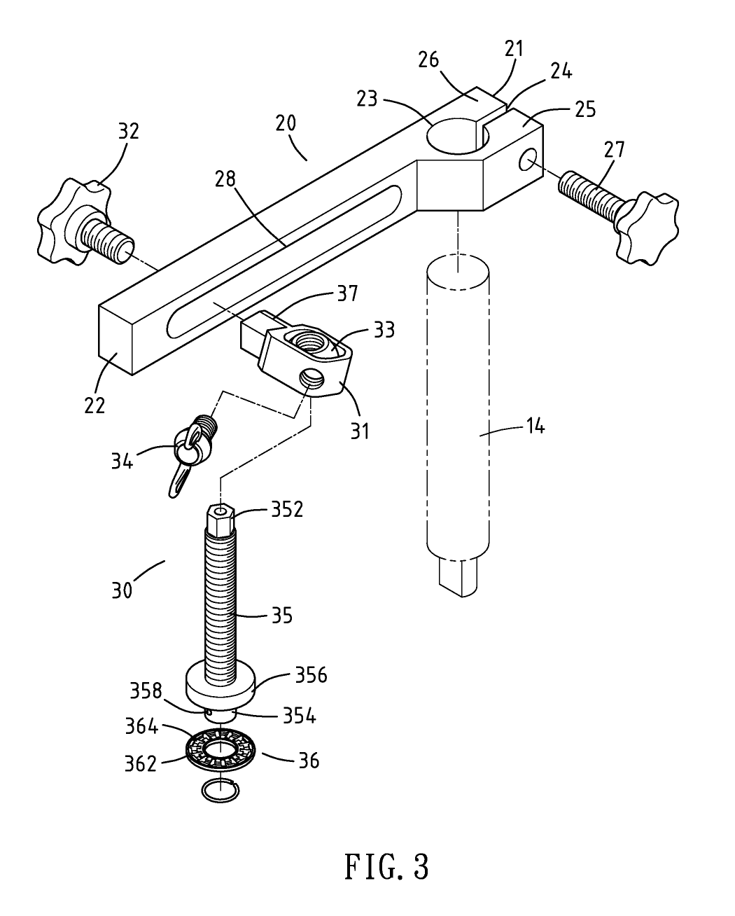

Referring to FIGS. 1 to 3, the engine valve spring removing/installing kit of the present invention comprises a frame 10, an arm 20, an adjustment device 30 and a presser 40. The frame 10 comprises an elongate base 11, two legs 12, two bolts 13 and a post 14. The base 11 has two elongate holes 112 and a passage 114 defined therethrough. The two elongate holes 112 are located close to the two ends of the base 11 respectively and the passage 114 is located between the two elongate holes 112. The two legs 12 are connected to the underside of the base 11 and the bolts 13 respectively extending through the legs 12 and the base 11 so that the frame 10 is fixed to the engine by the two bolts 13. The two respective top ends of the two legs 12 extend through the two elongate holes 112. The legs 12 support the base 11 which is movable relative to the two legs 12. The post 14 extends from the top of the base 11. The post 14 has an insertion 142 extending from the lower end thereof. The insertion 142 is inserted into the passage 114. The insertion 142 has a flat contact face 144 defined in the outer periphery thereof. A locking bolt 15 threadedly extends through the base 11 and contacts against the contact face 144 to position the post 14. Therefore, the post 14 and the base 11 are not rotatable relative each other.

The arm 20 is an elongate arm and has a first end 21 and a second end 22. A through hole 23 is defined through the arm 20 and located close to the first end 21. The post 14 is pivotably connected to the arm 20 by extending through the through hole 23. A slit 24 is defined longitudinally through the first end 21 of the arm 20 and communicates with the through hole 23. Two lugs 25, 26 are formed with the slit 24 located therebetween. A first positioning member 27 extends through the lug 25 and is threadedly connected to the lug 26 to lock the arm 20 to the post 14. A slot 28 is defined through the arm 20 and located between the second end 22 and the through hole 23.

The adjustment device 30 comprises a retainer 31, a second positioning member 32, a ball 33, a third positioning member 34, a threaded rod 35 and a rotary member 36. The retainer 31 is located on one side of the arm 20 and has an extension 37 which extends through the slot 28 and is threadedly connected with the second positioning member 32 so that the retainer 31 is movable along the slot 28. The second positioning member 32 locks the retainer 31 and the ball 33 is rotatably retained in the retainer 31. The third positioning member 34 is threadedly connected to the retainer 31 and contacts the ball 33 to position the ball 33. The threaded rod 35 extends through the ball 33 and has an operation section 352 on the top end thereof which is cooperated with a tool to rotate the threaded rod 35. A connection section 354 extends from the bottom end of the threaded rod 35. The threaded rod 35 has a support portion 356 extending radially therefrom which is located close to the connection section 354. The operation section 352 is a polygonal rod so that a tool is able to clamp the operation section 352 to rotate the threaded rod 35. The connection section 354 is pivotably connected to the presser 40. The support portion 356 supports the presser 40. The connection section 354 is connected to the rotary member 36 which is located adjacent to the support portion 356. The rotary member 36 has a plate 362 with multiple rollers 364 accommodated therein so as to allow the presser 40 to be rotatable relative to the support portion 356. The connection section 354 has a bead 358 connected to the outside thereof.

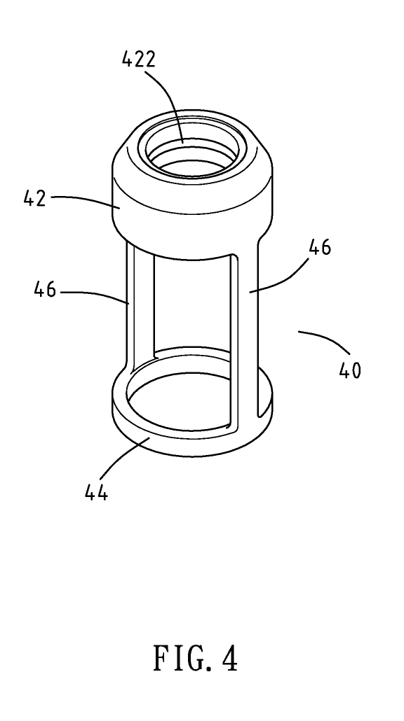

The presser 40 is used to force the valve to move axially so as to replace the engine valve springs. As shown in FIG. 4, the presser 40 has a top collar 42, a bottom collar 44 and two connection rods 46 which are connected between the top and bottom collars 42, 44. The top collar 42 is pivotably connected to the connection section 354, and the annular groove 422 is defined in the inner periphery of the top collar 42 so that the bead 358 is engaged with the annular groove 422. The threaded rod 35 is pivotably connected with the presser 40, and the presser 40 is pivotable relative to the threaded rod 35.

When in use, the top cap of the engine is removed, and the base 11 and the legs 12 are connected to the housing of the engine by the bolts 13. By the elongate holes 112, the base 11 is movable relative to the legs 12 so as to adjust the position of the base 11. When the base 11 is positioned, the post 14 is securely connected to the base 11 by the locking bolt 15 to install the frame 10 to the engine.

When the frame 10 is set, the arm 20 is connected to the frame 10 and the adjustment device 30 is connected to the arm 20. Then the presser 40 is connected to the adjustment device 30.

After the kit is installed to the engine, while the frame 10 is firmly positioned, the arm 20 and the adjustment device 30 are then adjusted to change the position of the presser 40 and the angle between the axis of the presser 40 and the vertical plane to align the presser 40 with the valve. The threaded rod 35 is then rotated by using a tool to move the presser 40 axially such that the valve is forced to move axially, such that the valve springs are conveniently replaced.

Because the threaded rod 35 is connected to the presser 40, and the ball 33 is rotatable in the retainer 31, so that the presser 40 and the threaded rod 35 can be pivoted about the frame 31 in different angles and directions. Therefore, the presser 40 is adjusted to be desired angles. When the first valve spring is removed or installed, and the adjacent valve spring is to be removed or installed, the frame 10 does not need to be moved. The arm 20 and the adjustment device 30 are adjusted and the presser 35 is rotated to another proper angle to proceed the removal or installation steps to the valve spring to be removed or installed.

While we have shown and described the embodiment in accordance with the present invention, it should be clear to those skilled in the art that further embodiments may be made without departing from the scope of the present invention.

What is claimed is:

1. An engine valve spring removing/installing kit, comprising:
a frame having an elongate base, two legs, two bolts and a post, the two legs connected to an underside of the base and the bolts respectively extending through the legs and the base, the frame adapted to be connected to an engine by locking the bolts to the engine, the post extending from a top of the base;
an arm being an elongate arm and pivotably and radially connected to the post by a first positioning member, an elongate slot defined through the arm;
an adjustment device having a retainer, a second positioning member, a ball, a third positioning member, a threaded rod and a rotary member, the retainer located on one side of the arm and having an extension which extends through the slot and is connected with the second positioning member so that the retainer is movable along the slot, the second positioning member locking the retainer, the ball being rotatably retained in the retainer, the third positioning member threadedly connected to the retainer and contacting the ball to position the ball, the threaded rod extending through the ball and having an operation section on a top end thereof which is adapted to be cooperated with a tool to rotate the threaded rod, a connection section extending from a bottom end of the threaded rod, and
a presser pivotably connected to the connection section, the threaded rod having a support portion extending radially therefrom which is located close to the connection section, the support portion supporting the presser and the connection section connected to the rotary member so that the presser is rotatable relative to the presser.

2. The kit as claimed in claim 1, wherein the base has a passage defined therethrough and the post has an insertion extending from a lower end thereof, the insertion is inserted into the passage.

3. The kit as claimed in claim 2, wherein the insertion has a flat contact face defined in an outer periphery thereof, a locking bolt threadedly extends through the base and contacts against the contact face to position the post.

4. The kit as claimed in claim 1, wherein the base has two elongate holes defined therethrough, the two legs movably extend through the two elongate holes.

5. The kit as claimed in claim 1, wherein the connection section has a bead connected to an outside thereof, the presser has an annular groove with which the bead is engaged so as to pivotably connect the presser with the threaded rod, the presser is pivotable relative to the threaded rod.

6. The kit as claimed in claim 5, wherein the presser has a top collar, a bottom collar and two connection rods which are connected between the top and bottom collars, the top collar is pivotably connected to the connection section, the annular groove is defined in an inner periphery of the top collar.

7. The kit as claimed in claim 1, wherein the arm has a first end and a through hole is defined through the arm and located close to the first end, the post is pivotably connected to the arm by extending through the through hole, a slit is defined longitudinally through the first end of the arm and communicates with the through hole, two lugs are formed with the slit located therebetween, the first positioning member extends through the two lugs to lock the arm to the post.

8. The kit as claimed in claim 1, wherein the operation section is a polygonal rod.

9. The lit as claimed in claim 1, wherein the rotary member has a plate with multiple rollers accommodated therein so as to allow the presser to be rotatable relative to the support portion.
